(19) United States
(12) Patent Application Publication
(10) Pub. No.: US 2015/0363818 A1
(43) Pub. Date: Dec. 17, 2015

(54) Digital display platform for promotional/advertisement/gaming inclusive of static and motion graphic images with method of use

(71) Applicant: Brian R. Keathley, Sherman Oaks, CA (US)

(72) Inventor: Brian R. Keathley, Sherman Oaks, CA (US)

(21) Appl. No.: 14/307,230

(22) Filed: Jun. 17, 2014

(51) Int. Cl. G06Q 30/02; G06T 13/80; G09F 27/00

(52) U.S. Cl. CPC G06Q 30/0241; G09F 27/00; G06T 13/80

(57) ABSTRACT

A Motion Poster or Moster is the creation or recreation of a static movie poster, flyer or banner with the objective of bringing them to life through digital movement and animation. Mosters can be played on a video player, monitor, television, computer, phone, cellphone, LED, pad/tablet, gas pump display, sticker, label, over-sized screen or projected and can be watched lenticularly, (auto)stereoscopically, or in 2 d, 3 d, 4 k, 8 k, HD, Blu-ray, IMAX, curved or by hologram. In addition, the use of touch-sensitive and voice-activated screens may be used for interaction with the advertisement. Locations for display may be at bus stops, restaurants, car dealerships, billboards, theaters, homes, shopping malls, retails stores or from local or remote video players streaming from local or remote cloud locations. Mosters are intended to invoke a feeling, emotion or desire through motion and expression that a static marketing poster is incapable of expressing.

### CROSS-REFERENCE TO RELATED APPLICATIONS

application Ser. No. 14/307,230

Original Filing Date Jun. 17, 2014

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Posters for movies have been used to promote and market a film for decades. Movie posters, typically printed onto paper or vinyl have been displayed in theaters, malls, bus stops and other public areas and sold in large chain stores, collectable stores and online. These posters, while used for promotion and marketing of the latest movies as an example, provide great value to the movie studios and movie goers alike by providing a brief explanation of a film through the use of an illustration or photograph. This method, which encompasses limited functionality and impact, misses a key element in the fundamental explanation and important component that varies among different genres that cannot be relayed in a static image. These posters are also limited in the amount of content that they can provide to the “viewer” as well as limiting engagement potential and future sales derived from said poster for the advertiser.

Currently, posters are used in everyday life to promote and market brands, products, cosmetics, cars, real estate, restaurants, services, charities, politicians, announcements, movies and television. These typical static posters, flyers and banners that been around for centuries are now antiquated.

### FIELD OF THE INVENTION

This invention is an improvement to the method in which movie, music, book, game, general advertising posters, or other promotional materials are displayed. This invention adds motion or a “moving frame” and audible component to the static image as additional elements and displayed as a whole or in part onto a display device.

### DESCRIPTION OF RELATED ART INCLUDING INFORMATION DISCLOSED

Not Applicable

### BRIEF SUMMARY OF INVENTION

Average posters and promotions provide great value in the advertising and marketing industry by helping to promote brands and products. By adding animation and motion to the advertisements, these improved ads can help brands and industries evolve by connecting deeper into the cognitive senses of product users in a fun and informative way through recognizable pictures and images that will better explain and illustrate the products or brands that interest them.

### BRIEF DESCRIPTION OF THE SEVERAL VIEWS OF THE DRAWINGS

FIG. 1a: The Moster starts-out in a static position.

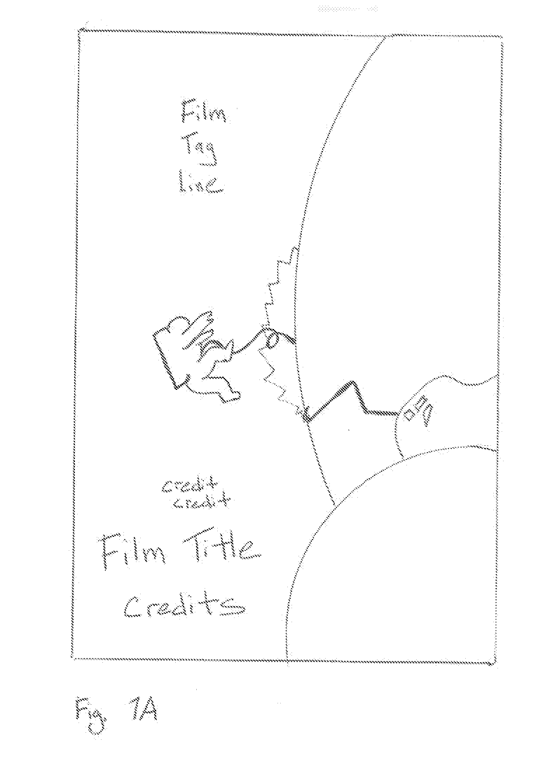

FIG. 1b: Once the Moster begins its sequence, the elements of the Moster begin to move, appear or disappear. This illustration shows that much of the elements have disappeared.

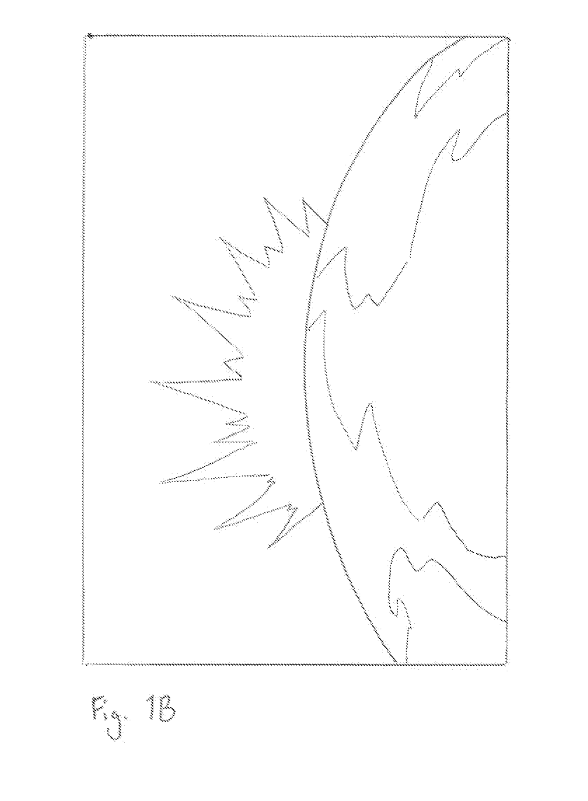

FIG. 1c: This illustration shows elements of the Moster as they reappear in the action and movement of the Moster.

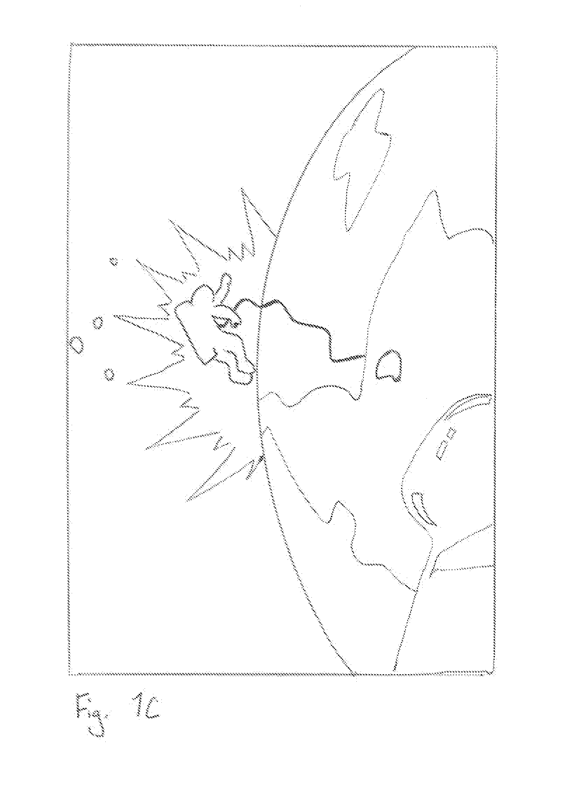

FIG. 1d: This illustration shows the Moster as it nears completion.

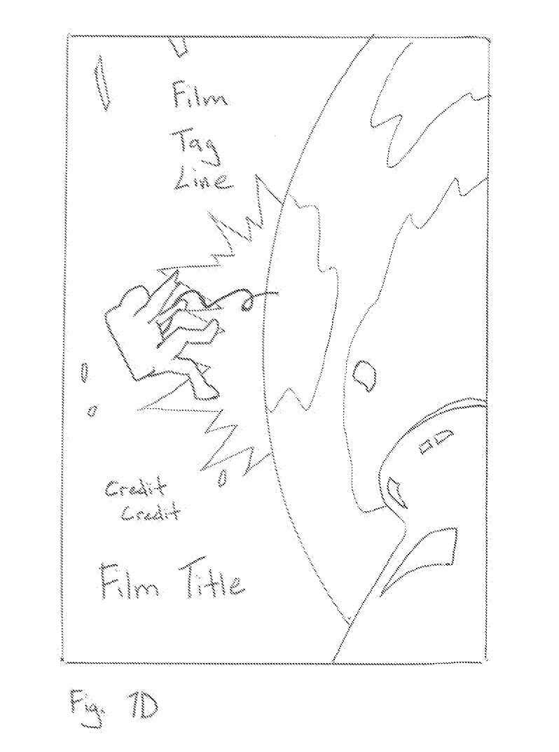

FIG. 1e: This illustration shows that the elements have now disappeared and a tagline from the movie is now being displayed, along with beats of the background noises.

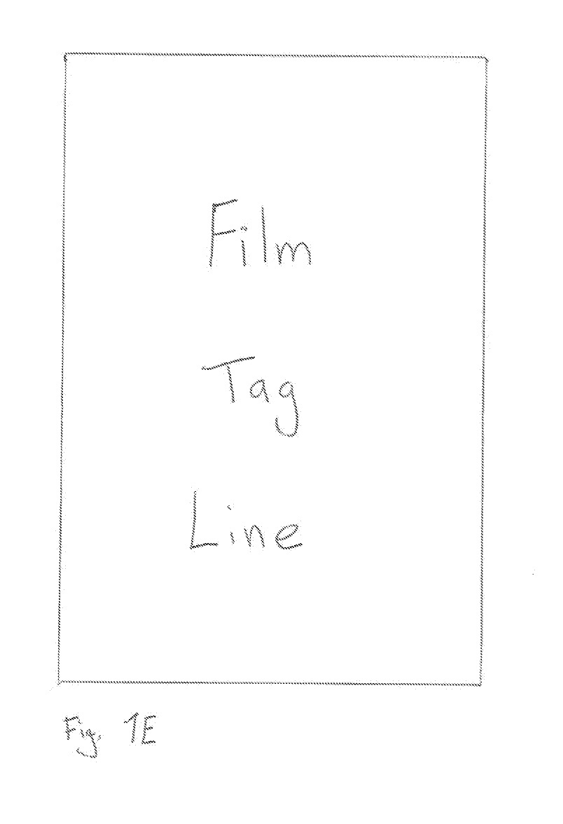

FIG. 1f: The Moster completes its first round of play and either stops at the completed static image or continues to replay in a loop.

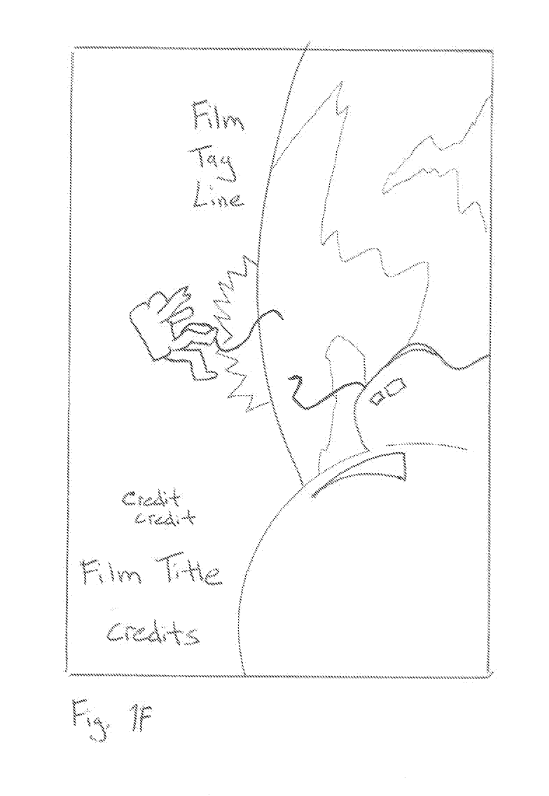

FIG. 2a: Static start.

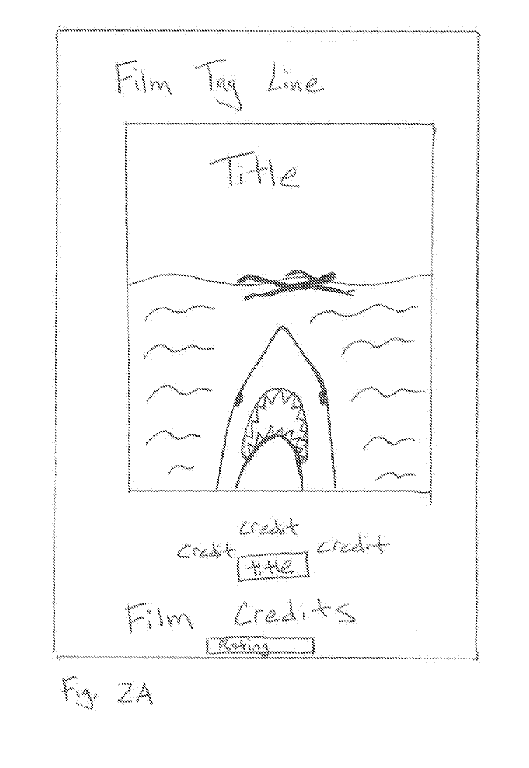

FIG. 2b: Starts to play.

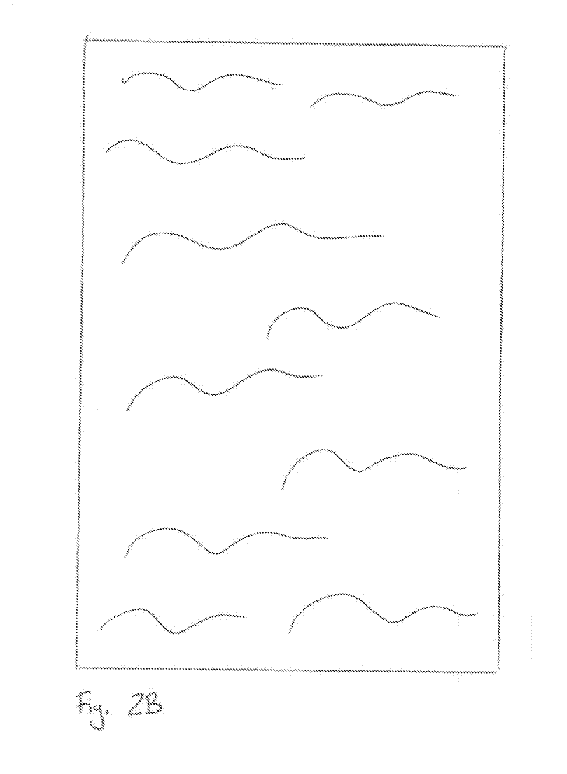

FIG. 2c: Middle of play action.

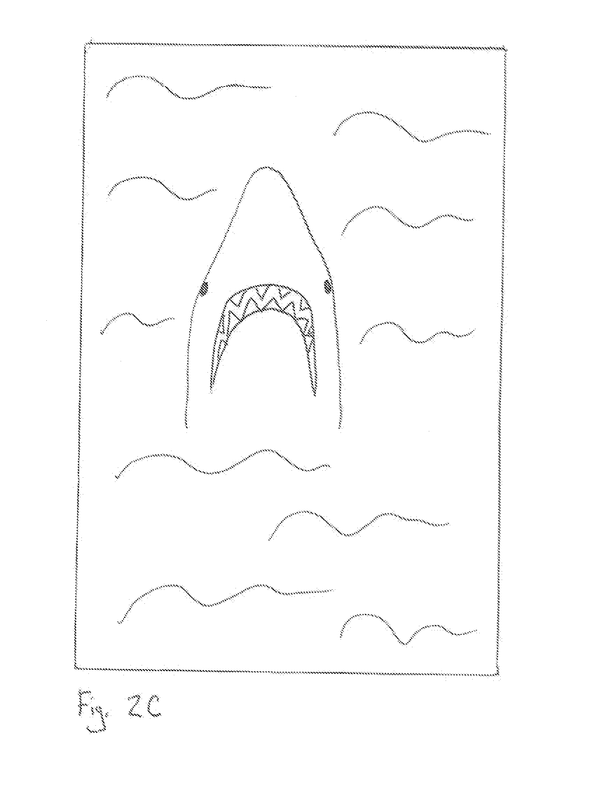

FIG. 2d: Towards the end.

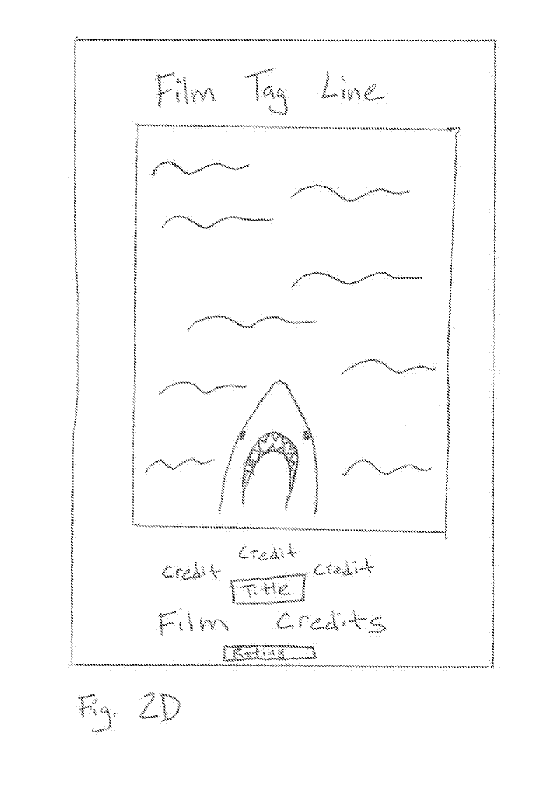

FIG. 2e: Static ending, or the beginning if on a loop.

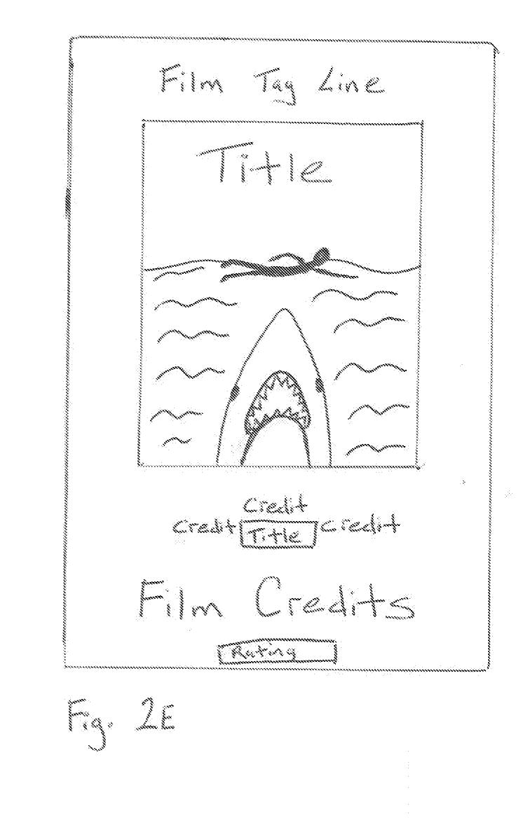

FIG. 3a: Static start.

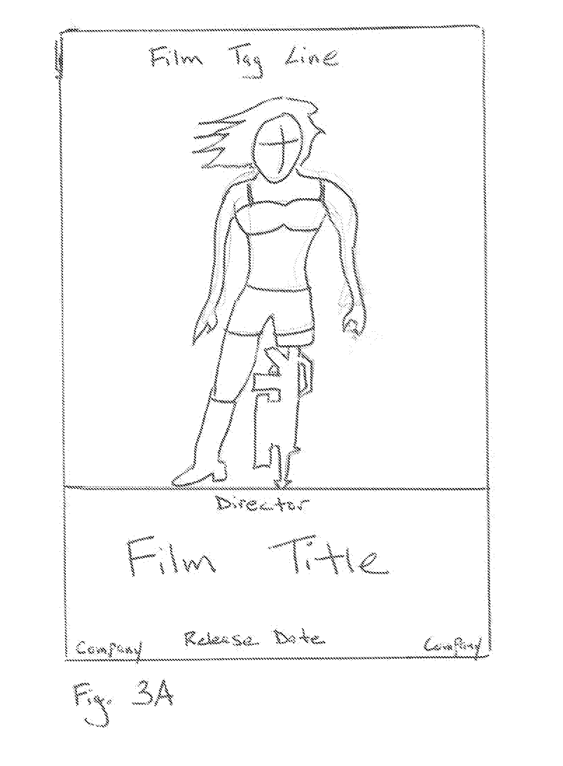

FIG. 3b: Starts to play.

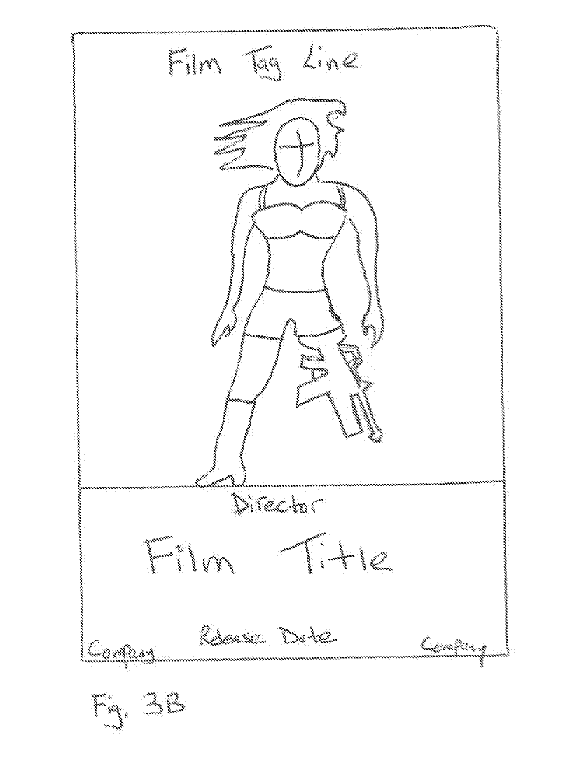

FIG. 3c: Middle of play action.

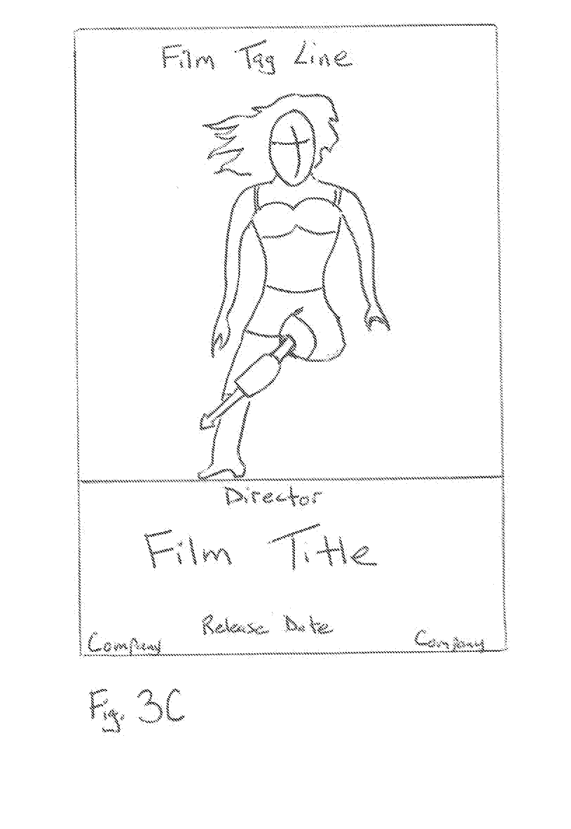

FIG. 3d: Towards the end.

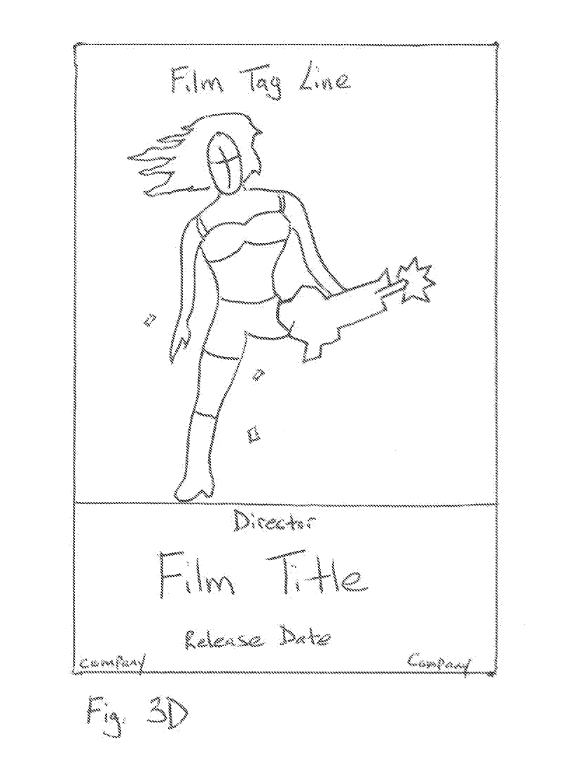

FIG. 3e: Static ending, or the beginning if on a loop.

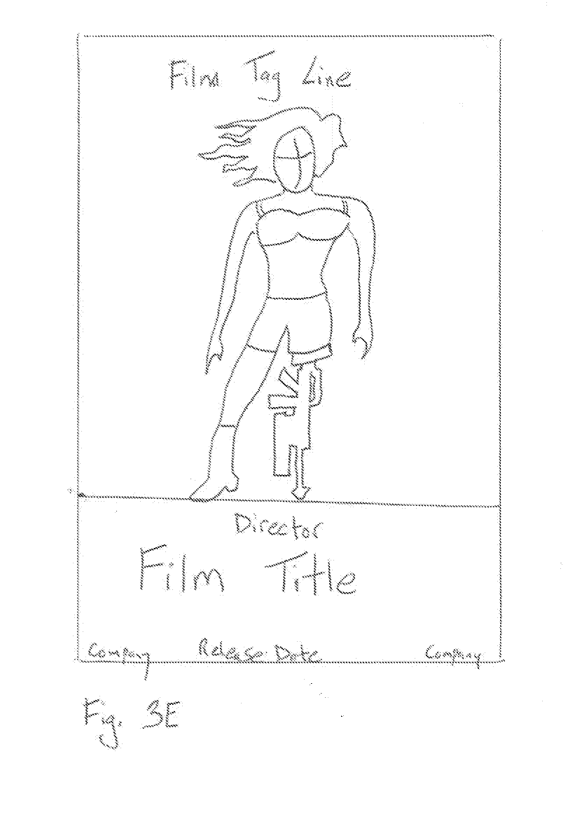

### DETAILED DESCRIPTION OF THE INVENTION

Mosters (trade name: as we will refer to them in this application) is the creation or recreation of a poster, flyer or banner with the objective of bringing them to life through digital movement and animation. Users and passer-byes no longer have to guess or wonder as to the true meaning and feeling behind the message being endorsed.

The first Moster was created in 2007 and resides on GeekNation.com. Since, various styles of looping or non-looping motion posters have been created using said technology, implementing countless variations of style and design.

A Moster or motion poster is a high-resolution animation of an original poster, artwork or advertisement. Mosters have a resolution ranging from 64×64 pixels up to 8,192×8,192 pixels but most likely in a range from 1920×1080 up to 4096×2160 lines at varying frame rates as common in the standards. 24 frames per second up to 120 frames per second and higher for slow-motion effects are most likely to be utilized.

Mosters can be played on a video player, monitor, television, computer, phone, cellphone, LED, pad/tablet, gas pump display, sticker, label, over-sized screen or projected and can be watched lenticularly, (auto)stereoscopically, or in 2 d, 3 d, 4 k, 8 k, HD, Blu-ray, IMAX, curved or by hologram. In addition, the use of touch-sensitive and voice-activated screens may be used for interaction with the advertisement. Locations for display may be at bus stops, restaurants, car dealerships, billboards, theaters, homes, shopping malls, retails stores or from local or remote video players streaming from local or remote cloud locations.

Mosters may be set to play on a constant, interval, motion, sound, weight, heat sensing, or time delayed loop, adding an element of surprise to the viewer, prompted to play by either the push of a button, pressing play on a player or prompted to play automatically by a motion or weight sensor. A voice activated, touch or motion sensor may also be employed into the hardware system allowing for the start of or interaction with the content as well as selection of new content allowing for multiple advertisements to be placed at one location.

The visual elements of a Moster can be created and played with music, beats, background noise, white noise, natural sounds, dialogue and voiceovers.

The movement and animation within the Moster can be created from live action, photos, hand drawn or computer animation, static objects, layered files, letters, numbers, natural objects, artwork, humans, animals or parts thereof.

Mosters can be created with an ‘Easter egg’, which is an intentional inside joke, hidden message, or feature in a work such as a computer program, video game, movie, book, or crossword. The name has been said to evoke the idea of a traditional Easter egg hunt. This feature may be in the form of a random event or object appearing on-screen or via touch-sensitive, interactive screen and discovered by the user. In the form of a random event such as an image or “wining code” a passer-bye might see/discover said code to win a movie ticket or other prize. Likewise an actor from the movie may make a random appearance on screen with a “funny quip” or behind the scenes insight.

A Moster can be created with ‘Annotations’ added to the visual display. Annotations are clickable text overlays on videos. Annotations are used to boost engagement, give more information, and aid in navigation, allowing a user to click on the annotation, linking the user to somewhere instructed by the annotation itself.

Mosters may be utilized not only in public areas but may also be integrated into services such as iTunes, Netflix, HULU, Amazon or other streaming services in order to engage the customer while searching content on a personal or home display device. Gaming systems such as XBOX and Sony Playstation as well as Cable set top boxes containing Pay-per-view material are also appropriate for the technology.

Mosters are intended to invoke a feeling, emotion or desire through motion and expression that a static marketing poster is incapable of expressing.

### SEQUENCE LISTING

Not Applicable

1. A method for generating a digital animated display of a movie poster from a static image of a movie poster, comprising acts of:
obtaining a static image of a movie poster, the static image having a background, at least one foreground object, and a title;
digitally removing at least one of the foreground object and title, leaving at least the background; and
animating at least one of the foreground object and title and overlaying the animated foreground object or title over the background for display to a viewer.
